(19) United States
(12) Patent Application Publication
(10) Pub. No.: US 2014/0022388 A1
(43) Pub. Date: Jan. 23, 2014

(54) Air Surveillance System for Detecting Missiles Launched from Inside an Area to be Monitored and Air Surveillance Method

(71) Applicants: Manfred Hiebl, Neuburg a.d. Donau (DE); Hans-Wolfgang Pongratz, Taufkirchen (DE)

(72) Inventors: Manfred Hiebl, Neuburg a.d. Donau (DE); Hans-Wolfgang Pongratz, Taufkirchen (DE)

(73) Assignee: EADS Deutschland GmbH, Ottobrunn (DE)

(21) Appl. No.: 13/983,513

(22) PCT Filed: Feb. 2, 2012
(86) PCT No.: PCT/DE12/00093

§ 371 Date: Oct. 8, 2013

(30) Foreign Application Priority Data
Feb. 4, 2011 (DE) 10 2011 010 339.2

(51) Int. Cl. H04N 7/18

(52) U.S. Cl. CPC H04N 7/181
USPC 348/144

(57) ABSTRACT

An airspace surveillance system for the detection of missiles launched within a space being monitored, having at least two surveillance platforms positioned outside or on the edge of the space being monitored in such a manner that the space or a part of the space is situated between the monitoring platforms. Each of the monitoring platforms is equipped with at least one camera system in such a manner that the lines of sight of the camera systems of the two monitoring platforms being positioned opposite to and facing each other.

### TECHNICAL FIELD

Exemplary embodiments of the present invention relate to an airspace surveillance system for the detection of missiles launched inside a space being monitored, having at least two monitoring platforms. Exemplary embodiments of the present invention also relate to a method for airspace surveillance by means of such an airspace surveillance system.

### BACKGROUND OF THE INVENTION

In order to make it possible to combat armed intermediate-range missiles or long-range missiles prior to their reaching their targets, it is necessary to know the flight path of the missile. Particularly in situations where these missiles have a nuclear warhead, the defense against these missiles must take place as much as possible over the territory from which the missiles are launched, in order to elevate the risk (for the state which launches these missile) of radioactive fall-out contaminating the territory of that state upon the destruction of the missile. If it is not possible to destroy the missile over the launch territory, then such missiles should be destroyed at a very great height in their flight path in order to minimize collateral damage resulting from concentrated radioactive fall-out. For this reason, it is necessary to acquire such missiles very early after launch, and to execute a reliable trajectory evaluation of the missile flight path very early.

The general prior art includes satellites for such surveillance, which fly in high orbit paths, wherein the surveillance devices thereof are oriented toward the earth from above. These surveillance devices work in the infrared range of wavelengths from 2.6 to 4.6 μm. As a result of the dense interference background, including a number of heat radiation sources at ground level and sunlight reflections on the surfaces of clouds or water, these known surveillance systems detect a dense interference background which can lead to false alarms.

Other known surveillance devices are made up of radar systems stationed along an expected missile flight route, in order to detect a missile flying in this manner and carry out a trajectory determination. This method of surveillance requires a great deal of cost and complexity, and frequently cannot be implemented for political reasons. In addition, such radar stations only determine the position of a flying missile; and while they can measure the radar backscatter cross-section, they are not able to undertake a more precise identification of the detected object. For this reason it is possible to render such radar systems useless by sending out decoys.

### SUMMARY OF THE INVENTION

Exemplary embodiments of the present invention are directed to an airspace surveillance system capable of detecting missiles shortly after their launch, identifying the same, and determining their flight path. Exemplary embodiments of the present invention are also directed to a corresponding method for airspace surveillance by means of such an airspace surveillance system.

In accordance with exemplary embodiments of the present invention, the airspace surveillance system, which detects missiles launched within a space being monitored, has at least two surveillance platforms positioned outside or on the edge of the space being monitored in such a manner that the space or a part of the space is situated between the monitoring platforms, wherein each of the monitoring platforms is equipped with at least one camera system as a sensor in such a manner that the lines of sight of the camera systems (sensors) of two monitoring platforms, the same being positioned opposite each other, face each other.

The airspace surveillance system according to the invention allows observation of the space being monitored or the monitored part of the space in question from two lines of sight, and to home on a detected object from at least two directions, thereby enabling a position determination of the object. The use of an imaging sensor in the form of a telescopic camera system allows identification of the object by means of, for example, matching multispectral images, such that a comparison of the target object with known target object reference images can be used to determine whether the detected object is a missile or a decoy, by way of example.

It is particularly advantageous if three or more monitoring platforms are employed at positions spaced apart from each other, outside or on the edge of the space being monitored. In this manner, it is possible to significantly improve the precision of the position determination of the detected object and the precision of the tracking of this object.

It is also advantageous if at least two pairs of the monitoring platforms are employed, wherein the space being monitored or a part of the space being monitored is situated between the two monitoring platforms of each pair. In this manner, it is possible to reliably monitor the entire space, particularly if two of these pairs are positioned at the “corners” of the space being monitored, and to therefore carry out reliable positioning of detected objects.

It is particularly advantageous if each of the camera systems of the airspace surveillance system is designed to detect and track objects moving at a great distance, and if, for this purpose, each of the camera systems is equipped with a camera having a camera lens and a position stabilization device for the camera and the camera lens, wherein the camera has a first image sensor with a high-speed shutter assigned to the same; a second image sensor with a second high-speed shutter assigned to the same; wherein the camera lens has a device consisting of optical elements for focusing incident radiation on a radiation-sensitive surface of the first image sensor and/or the second image sensor by means of at least one reflector telescope arrangement and at least one tracking mirror arrangement, and is configured with a drive device for at least one moving element of the target tracking mirror arrangement, and one control device for the drive device, and wherein the device consisting of optical elements has a first sub-unit of optical elements functionally assigned to the first image sensor and having a first focal distance, and a second sub-unit of optical elements functionally assigned to the second image sensor and having a second focal distance which is shorter than the first focal distance.

This position stabilized camera with a telescopic lens, which is particularly suitable for imaging distant objects, is capable of scanning the space being monitored by means of the element controlled via the control device and moved by the drive device, the element being a tracking mirror, by way of example, using the image sensor assigned to the shorter focal length, in order to detect the light emitted by the exhaust plume of a missile in launch. If a detection of an object has taken place, then it is possible to obtain an enlarged picture of the detected object by means of the first image sensor configured with the longer focal distance, thereby simplifying the identification of the object. In this manner, it is possible to determine whether the detected object is a missile, and the same can also be identified on the basis of the enlarged picture.

To this end, the optical beam path between the first sub-unit and the second sub-unit is preferably able to switch between the two, wherein a moving and particularly pivotable reflector is included for the purpose of this switching.

The image sensor preferably has a sensitivity maximum in the spectral wavelength range from 0.7 μm to 1.7 μm. In this wavelength range, all missile propulsion fuels known today give off a reliable, stable signal of more than 1,000,000 Watts/m2 during combustion. In addition, the atmosphere of the earth has a window with high light permeability in this wavelength range above a height of 15 km, such that there is high visibility in this spectral range. In one preferred embodiment, the image sensor has an indium gallium arsenide CCD sensor chip, which is preferably un-cooled. Such a sensor chip is particularly sensitive in the spectral range from 0.7 μm to 1.7 μm, and has a maximum sensitivity close to the theoretical sensitivity threshold. It is particularly advantageous if this sensor chip is of high resolution and is highly light-sensitive and low-noise in the near infrared range.

Each of the high-speed shutters of the cameras is preferably designed in such a manner that the image sensor assigned thereto can make a plurality of individual images in rapid succession, and preferably at a frequency of 50 images per second, and more preferably at 100 images per second. This rapid sequence of individual images makes it possible to scan a large search volume, meaning a large horizontal and vertical angle of view, in a rapid succession, such that the camera scans carried out in this manner ensure a high degree of reliability for the detection of moving objects which emit light.

It is particularly advantageous if at least one of the sub-units of optical elements has a Barlow lens set, preferably combined with a field flattener. A Barlow lens set makes it possible to achieve high light transmission at long focal distances, and therefore high sensitivity. The field flattener largely removes the curvature of the field of the image present in Dall-Kirkham and Ritchey-Chretien reflector telescopes, and therefore enables much sharper images with the camera compared to the uncorrected configuration.

In a further preferred embodiment, the camera has a filter arrangement consisting of multiple spectral filters each of which can be inserted into the optical beam path if required, and the filter arrangement is preferably designed as a filter wheel. After being inserted into the optical beam path, such a filter arrangement, particularly such a fast-rotating filter wheel with three band-pass filters, for example, which cover the entire spectral range, can produce sequential false-color images of the moving object which radiates light and heat energy, for example a missile trail. While the camera has high resolution enabling imaging the light source—meaning the missile trail, by way of example—on multiple pixels of the sensor, the images also contain sufficient shape, color, and spectral information that make it possible to carry out an identification of the target object by multispectral image correlation with known reference images.

It is particularly advantageous if the camera system is further configured with a target illuminating device having a radiation source, preferably a laser diode radiation source or a high-pressure xenon short-arc lamp radiation source. The radiation source is preferably designed as a laser array or a xenon short-arc lamp with an aspherical collimating lens and pinhole collimator. By means of the target illuminating device, once the missile is detected, it can also continue to be followed even if it no longer emits light and/or heat radiation, or only emits a very minimal amount of radiation. This is the case when the combustion period of the missile propulsion system comes to an end. This target illuminating device, which is preferably composed of a near infrared laser diode target illuminating device or a near infrared high-pressure xenon short-arc lamp target illuminating device, illuminates the moving missile once the same has been acquired, and the camera receives the reflected radiation of the target illuminating device from the illuminated, moving missile.

The target illuminating device can preferably be coupled to the camera lens in such a manner that the target illuminating beam emitted by the target illuminating device can be coupled into the optical beam path of the camera lens to focus the emitted radiation. By using the same optical beam path in this way for the target illumination and the target imaging, it is possible to ensure a very precise adjustment of the illumination on the target object. With other means, this can only be achieved with disproportionately high cost and effort. Such a target illuminating device with a long focal distance makes it possible to generate a luminous spot at the distance of the target—meaning in the area of the moving missile, using the manifold surface of the missile, wherein the luminous spot is large enough to illuminate the missile, while there is still sufficient light reflected back to the image sensor of the camera system.

In this case, it is particularly advantageous if the camera lens has a reflector arrangement for the purpose of coupling-in the target illuminating beam, and the reflector arrangement is designed in such a manner that the optical beam path of the camera lens can be switched between the first image sensor and the target illuminating device synchronously with the emission of the illumination pulse and with the arrival of the echo pulse thereof. During this so-called “gated view” operation, a beam pulse generated by the target illuminating device is emitted by the camera lens onto the target, in this case onto the missile, while the beam path connecting to the associated image sensor is broken. The rate of this stroboscope-like target illumination is chosen in such a manner that the duration of each illumination pulse emitted at the target is shorter than the time required to travel the distance from the camera system to the missile and back. The duration of each illumination pulse emitted at the missile is preferably at least 40%, and particularly greater than 60%, of the time required to travel the distance from the camera system to the missile and back.

The beam source of the target illuminating device is preferably designed to transmit pulsed light flashes, preferably in the infrared range, wherein the intensity of the near infrared light flashes is preferably at least 1 kW, and more preferably 2 kW. The focusing of energy, together with the high pulse power of ideally 2 kW, transmits sufficient near infrared light to illuminate an object, by way of example a missile, at a distance of several hundred kilometers, in such a manner that the resulting light reflected by the object is sufficiently intense to still be detected by the sensor of the camera.

The camera system is more preferably configured with or connected to an image analysis device which works automatically, particularly an automatic multispectral image analysis device, wherein the image data of the images recorded by the camera is transmitted to the image analysis device. By means of this image analysis device, which is preferably designed as an automatic multispectral image analysis device, it is possible to identify automatically detected objects, given sufficient resolution and modulation depth of the received images. Particularly in the case of multispectral images, this can be implemented by multispectral correlation with known reference target images.

The monitoring platforms are preferably airborne, and more preferably each composed of an airplane, or are on board an airplane.

In this case, it is particularly advantageous if each airplane is a high-altitude airplane, and is positioned at the elevation of the stratosphere, preferably at approx. 38 km of altitude. It is difficult to get a fix on the location of airplanes at this altitude and to attack the same. In addition, the range of view is very long due to the thin atmosphere, particularly in the near infrared wavelength region.

It is particularly advantageous if a pivot device is additionally included by means of which the camera system is able to pivot between a monitoring position and a navigation position, and/or a communication position. This embodiment makes it possible to also use the camera system, when in the navigation position, for astronavigation to determine the position of the camera system. If this astronavigation is carried out with the same camera system as the positioning of an object detected by the camera, then measurement errors resulting from the camera system itself are neutralized, such that it is possible to achieve a higher precision of the positioning of the detected object. When in the communication position, it is possible to transmit modulated radiation signals, for example a data stream, to a base station or to other monitoring platforms of the airspace surveillance system, by way of example, and to receive modulated radiation signals from the same.

In this case, it is advantageous if the beam source of the target illuminating device is designed to be modulated by means of a data coupling device in order to be capable of transmitting data using the modulated radiation signal output when in the communication position, for example to a base station or to other monitoring platforms of the airspace surveillance system.

The method for airspace surveillance by means of an airspace surveillance system according to the invention involves systematically searching the airspace or a region of the airspace over the space being monitored, by means of at least one camera system of each monitoring platform, in a scanning procedure, wherein the camera system works in a scanning mode, for objects that give off a significantly higher heat radiation in proportion to their surroundings, and the camera system switches over from the scanning mode to a target tracking mode of a target tracking procedure once such an object giving off a large amount of heat radiation has been detected, wherein a smaller image segment that contains the detected object is recorded by the camera, by means of a greater focal distance, and the camera movement is tracked to this detected moving object.

One advantageous implementation of the method involves carrying out an object recognition for the detected object by an image analysis process, and particularly a multispectral image analysis process, once the camera system has been switched over into the target tracking mode, in order to identify the object using image data and/or multispectral reference target image data saved in a database. In this manner it is possible to reliably determine whether the detected object is a launched missile, or is possibly a decoy. In addition, it is possible to identify the type of missile, such that a target area the missile is aimed at can be determined by means of the known flight performance data thereof. In addition, specific combat measures can be initiated based on the determined missile type.

In a further advantageous embodiment, in the target tracking mode of the camera system, a target illuminating device is activated if the heat radiation signal emitted by the detected object disappears or drops below a pre-specified threshold, such that the target illuminating device illuminates the object. In this manner it is possible to continue to track the missile even after combustion has stopped in its propulsion system, whereby it is possible to more reliably track the trajectory and measure the flight path, and also to detect decoy maneuvers, such as the ejection of decoys, for example, in such a manner that it is still possible to initiate countermeasures.

It is particularly advantageous if the line of sight of the camera system of each monitoring platform is oriented from the location of the associated monitoring platform, through the monitored area of the airspace of the space being monitored, and toward outer space. Due to the reduced background noise, the sighting of the camera at the dark and cold background of space provides an even more reliable detection, even of the smallest light or heat sources, such that the usable range of the camera system is significantly improved compared to an observation system oriented toward the earth.

Following the detection of an object by one camera system of a monitoring platform, it is also advantageous if information on the line of sight and therefore on the sector of the monitored airspace in which the object was detected is transmitted from the detecting camera system to at least one camera system, and preferably two camera systems, of at least one and/or two other platforms, such that this/these further platform(s) direct their scanning activity to this sector of the airspace. It is also advantageous if, once at least one further camera system has detected the object, the camera systems that have detected the object then synchronously home on the object, in order to determine the current position and the trajectory of the detected object with high precision. This type of cooperative object tracking enables a precise measurement of the trajectory of the flight path even if the object is a great distance away.

Each monitoring platform preferably takes it own bearings from stars, using the camera of its camera system, to determine its position, thereby improving the precision of the positioning of the detected object and the determination of its trajectory, as described above.

Preferred embodiments of the invention, along with additional embodiment details and further advantages, are described and explained in greater detail below with reference to the attached drawing.

### BRIEF DESCRIPTION OF THE DRAWINGS

In the drawings,

FIG. 1 shows a simplified perspective illustration of an airspace surveillance system according to the invention, and a method for airspace surveillance carried out using the same;

FIG. 2 shows a top view of the airspace surveillance system in FIG. 1, indicated by the direction of arrow II;

FIG. 3 shows a schematic illustration of the optical construction and the beam paths of a camera system configured in the airspace surveillance system according to the invention;

FIG. 4 shows a schematic illustration of a target illuminating device of the camera system according to FIG. 2;

FIG. 5 shows a simplified perspective illustration of a trajectory tracking method using the airspace surveillance system according to the invention, analogously to the illustration in FIG. 1; and

FIG. 6 shows a top view of the airspace surveillance system in FIG. 5, indicated by the direction of arrow VI in FIG. 5.

### DESCRIPTION OF THE PREFERRED EMBODIMENTS

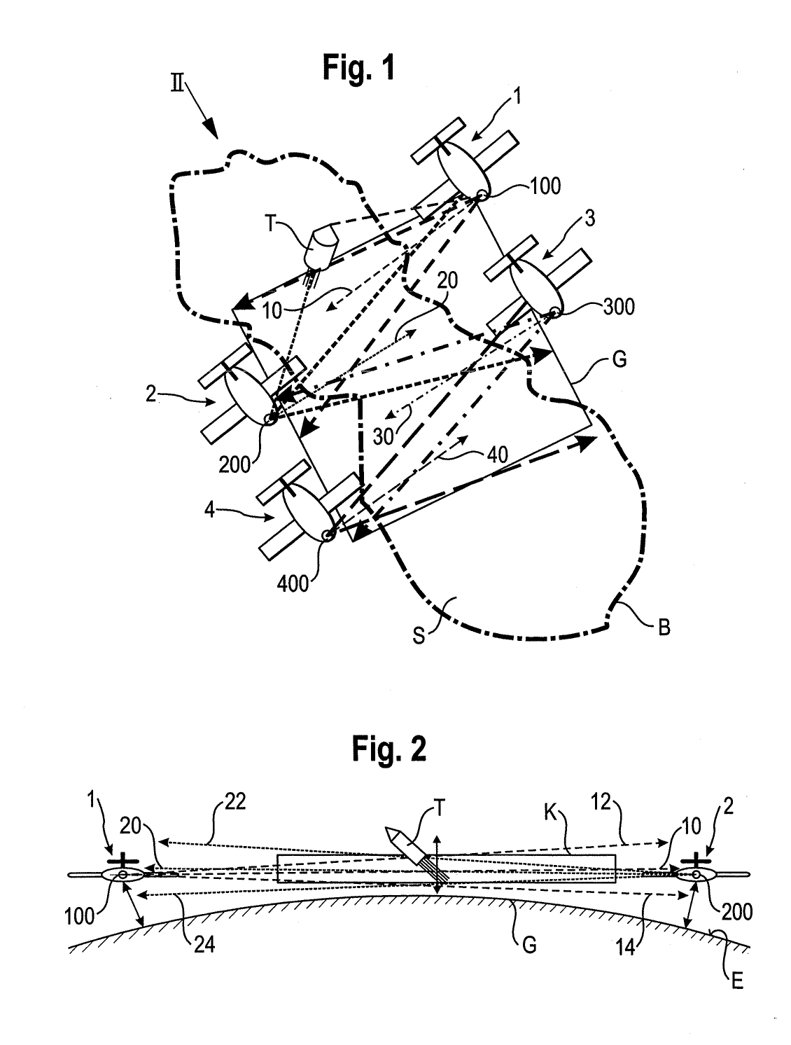

FIG. 1 illustrates an airspace surveillance system according to the invention in a schematic perspective view from outer space. The heavy, dashed Line B indicates the boundary of the territory of a state being monitored. Two high altitude airplanes are positioned as monitoring platforms 1, 2, 3, 4 at a distance from each other on two sides of this territory S, the sides being opposite each other. The high altitude airplanes can be designed, by way of example, in the manner which is described in German patent application 10 2010 053 372.6, which is not pre-published prior art. The disclosed contents of this German patent application are entirely incorporated into the disclosed contents of the present application. Each of these high altitude airplanes is equipped with at least one camera system 100, 200, 300, 400. The construction and functionality of each camera system are described in greater detail below in the context of the camera system 100. The other camera systems 200, 300, 400 are constructed in the same way, such that no description is included for the purpose of preventing repetition.

The lines of sight 10, 20; 30, 40 of the camera systems 100, 200; 300, 400 of two monitoring platforms 1, 2, 3, 4 positioned opposite each other and facing each other, and the space being monitored above the territory S extends between the two monitoring platforms 1, 2 and 3, 4—the same forming a pair. A space G being monitored is detected in this manner from the angles of view of each camera system 100, 200, 300, 400.

FIG. 2 shows the airspace surveillance system in FIG. 1, indicated by the direction of arrow II in FIG. 1. FIG. 2 shows how the angles of view 10, 20 of each of the camera systems 100, 200 situated on board the monitoring platforms 1, 2 are oriented toward each other, and how a monitoring corridor K of the space being monitored G spans the vertical area from the upper to the lower edge rays 12, 14; 22, 24 of the respective lines of sight 10; 20, such that a volume is defined as the airspace region V by the space being monitored G on the surface of the earth E and the monitoring corridor K, which is preferably monitored without gaps by the camera systems 100, 200, 300, 400 on board the monitoring platforms 1, 2, 3, 4.

Before details are given on the manner in which the airspace surveillance is carried out, the construction and the functionality of the camera systems 100, 200, 300, 400 positioned on board the monitoring platforms 1, 2, 3, 4 are described using the example of the camera system 100.

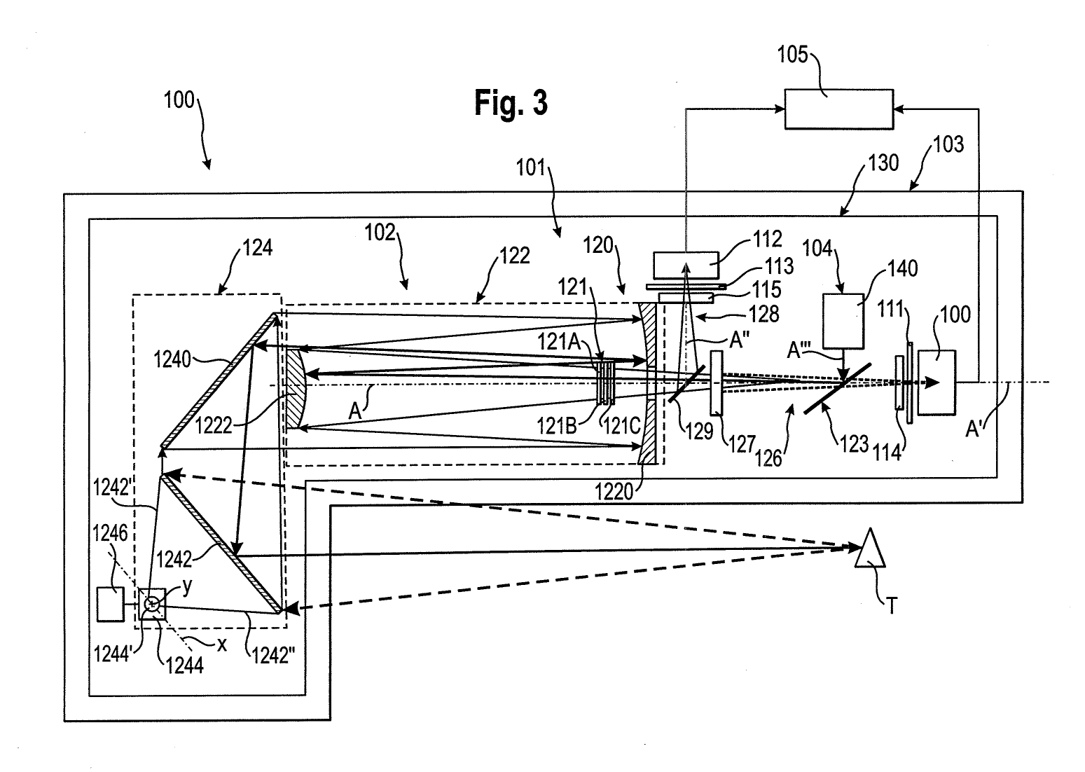

The camera system 100 has a camera 101 configured with a camera lens 102, which is arranged on a camera platform 103. The camera platform 103 is configured with a position stabilizer device 130 for the camera 101 and the camera lens 102. This is likewise only shown schematically in FIG. 3.

The camera 101 has a first image sensor 110 with a high-speed shutter 111. In addition, a high-frequency line of sight stabilizer and image rotation device 114 is functionally assigned to the first image sensor 110. The first image sensor 110 has an optical axis A′ corresponding to the optical axis A of the camera lens 102.

A second image sensor 112, having a second high-speed shutter 113 assigned to the same, and having a high-frequency line of sight stabilizer and image rotation device 115, is arranged between the camera lens 102 and the first image sensor 110, at an angle to the optical axis A of the camera lens 102, wherein the angle shown in FIG. 3 of the optical axis A of the camera lens 102, and of the optical axis A″ oriented to the second image sensor 112, is 90°.

The high-frequency line of sight stabilizer and image rotation devices 114, 115 detect high-frequency rotations of the mirror in the inertial system, by means of angular acceleration sensors on the target tracking mirror 1242, and from this calculate a correction movement for the mirror which stabilizes the line of sight of the reflector telescope 122 in space. Each image rotation device in this case compensates for undesired image rotations caused by movements of the target tracking mirror 1242, by means of counter rotations about the optical axis A′ using an auxiliary mirror system, or by means of counter rotations of the entire camera 101.

The two image sensors 110, 112 are preferably highly sensitive in the near infrared range, and for example are InGaAs CCD chips, preferably with a pixel size of 30 μm and an image repetition rate of 100 Hz maximum. The sensors 110, 112 are preferably highly sensitive in the wavelength range from 0.90 μm to 1.70 μm, and have a preferred image size of 250×320 image points in order to achieve a high image readout rate of 100 images per second.

The camera lens 102 has a device 120 consisting of optical elements for the purpose of focusing incident radiation onto a radiation-sensitive surface of the first image sensor 110 and/or of the second image sensor 112. This optical device 120 is configured with a reflector telescope arrangement 122, a target tracking mirror arrangement 124, a sub-unit 126 of optical elements functionally assigned to the first image sensor 110 and having a first focal distance f1, and a second sub-unit 128 of optical elements functionally assigned to the second image sensor 112 and having a second focal distance f2. The second focal distance f2 is shorter than the first focal distance f1. A fluorite flatfield corrector (FFC) 127 is included in the optical beam path of the first sub-unit 126. In the illustrated, preferred embodiment, the focal distance f1 of the camera lens 102 with the first sub-unit 126, wherein the image captured by the camera lens 102 on the first image sensor 110 is depicted in the first sub-unit 126, is 38.1 m. The focal distance f2 of the camera lens 102 with the second sub-unit 128, wherein the image captured by the camera lens 102 on the second image sensor 112 is depicted in the second sub-unit 128, is 2.54 m.

The reflector telescope 122 in this embodiment is preferably an IR Dall-Kirkham or an IR Ritchey-Chretien telescope with a flatfield corrector and Barlow lenses for the purpose of extending the focal distance, and has an aperture of 12.5″ (31.75 cm). This telescope is particularly suited for the near infrared range. The mirrors 1220, 1222 of the reflector telescope 122 are preferably configured with a gold surface silvering, and are therefore particularly suited for use as infrared telescope mirrors.

The optical beam path of the camera lens 102, with its optical axis A, can be switched by means of a switchable, preferably pivotable mirror 129 between the optical beam path of the first sub-unit 126, with the optical axis A′ oriented to the first image sensor 110, and the second optical sub-unit 128, with the optical axis A″ oriented to the second image sensor 112. In this manner, the image captured by the camera lens 102 can either be imaged on the first image sensor 110 or on the second image sensor 112.

The target tracking mirror arrangement 124 included on the side of the reflector telescope arrangement 122, which faces away from the image sensors 110, 112, has a first deflector mirror 1240 positioned in front of the reflector telescope arrangement 122, as well as a movable second deflector mirror 1242. This second deflector mirror 1242 is attached to a moving element 1244′ of a drive device 1244 by means of holders 1242′, 1242″ which are only illustrated schematically in the figure, in such a manner that the second deflector mirror 1242 can pivot about a first axis x and about a second axis y which is situated at a right angle to the first, by means of the drive device 1244 attached on the camera platform 103. A control device 1246 is included for the purpose of controlling the drive device 1244, and is only illustrated schematically in FIG. 3.

The reflector telescope arrangement 122 includes a filter arrangement 121 having multiple spectral filters 121A, 121B, 121C. These filters can each be inserted into the optical beam path if required. For this purpose, the filter arrangement is preferably designed as a filter wheel. The filters of the filter arrangement 121 are transparent to different wavelength regions over the total range from 0.90 μm to 1.70 μm, such that it is possible to filter out a fraction of the incident light from this wavelength range using one of the filters, which function as band elimination filters.

A target illuminating device 104 is configured with a beam source 140 in the region of the first sub-unit 126. The beam source 140 is preferably designed as a laser beam source, and preferably a high-pressure xenon short-arc lamp with an aspherical collimating lens and pinhole collimator, as a flash illuminating device which is coupled in via a high-speed sector mirror 123. The beam source 140 emits light along an optical axis A′″ which runs transverse, and preferably perpendicular to, the optical axis A of the camera lens 102. A moving reflector arrangement 123 is included at the region of the intersection of the optical axes A and A′″, which in the illustrated example consists of a rotating sector aperture, wherein the closed sector elements thereof are mirrored in order to deflect the light emitted along the optical axis A′″ into the direction of the optical axis A of the camera lens 102, and wherein the open sector elements thereof allow the passage of light from the camera lens 102 to the first image sensor 110. In this manner, it is possible to deflect light from the target illuminating device 104 through the camera lens 102 and onto a target T, and to in turn deflect light reflected from the target T back through the camera lens 102 onto the first image sensor 110, as is described further below.

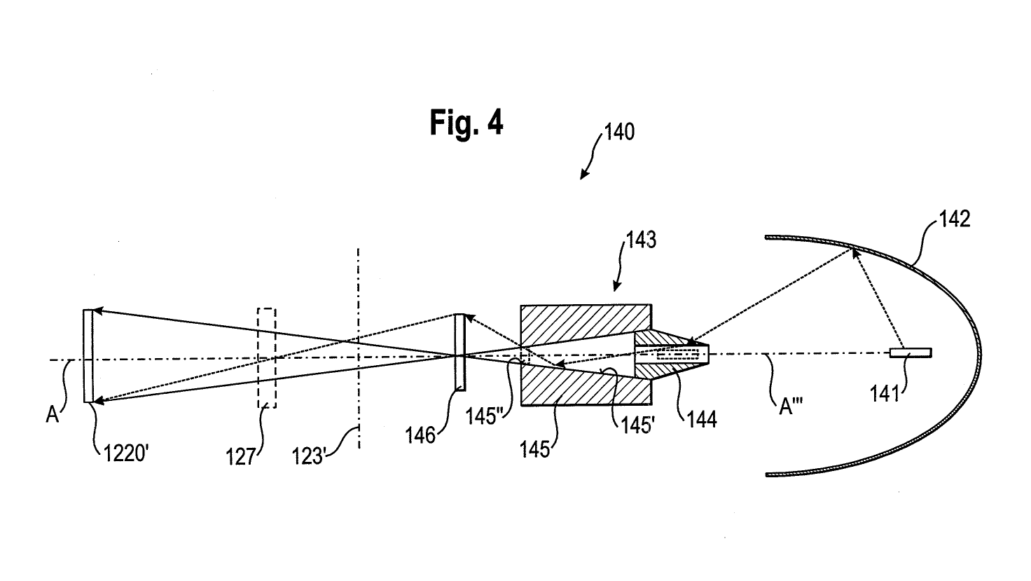

FIG. 4 shows an exemplary construction of the beam path 140 of the target illuminating device 104, which is only symbolically illustrated in FIG. 3. This beam source 140 is equipped with a xenon short-arc lamp and 12 kW of electrical power, by way of example, as well as beam power in the near infrared region of 1100 W.

An arc lamp 141 is arranged in an elliptical reflector 142, and generates a short-arc of approximately 14 mm in length and 2.8 mm in width. The light emitted by this arc is directed by the elliptical reflector 142 onto a condenser 143 which is configured on its light-input side with a sapphire glass hollow cone 144 as the condenser input, and an aperture block 145. The aperture block 145 has a light transmission opening 145′ that narrows from the light input side to the light output side, as well as an exit aperture 145″. The light transmission opening 145′ has a polished gold surface. The aperture block 145 is liquid cooled. The end of the sapphire glass hollow cone 144 on the light-output side thereof is inserted in the larger opening of the light transmission opening 145′ on the light-input side, as can be seen in FIG. 4.

An illumination condenser 146 is arranged behind the aperture block 145, and is formed by the exit aperture 145″ of the aperture block through the fluoride flatfield corrector 127 to the aperture 1220′ of the reflector telescope arrangement 122 (FIG. 3). In order to simplify the representation of the beam path in FIG. 4, the deflection of the optical axis A′″ of the beam source 140 to the optical axis A of the reflector telescope arrangements 122, which occurs by means of the mirror arrangement 123 at the point indicated by the dashed line 123′, is not shown.

The functionality of the camera system according to the invention is explained below.

The camera 101 is aimed at the target space G being monitored, with the second image sensor 112 activated and with the deflector mirror 129 pivoting into the optical beam path A of the reflector telescope arrangement 122. By means of a control computer (not shown) of a monitoring device, wherein the camera system 100 is a component thereof, the control device 1246 for the drive device 1244 of the second deflector mirror 1242 is controlled in such a manner that the second deflector mirror 1242, the same working as the target tracking mirror, executes a line-by-line scanning search movement of the target space. During the target space scanning search movement, the second image sensor 112 captures blanket-coverage images of the target space at a high image repetition frequency of 100 Hz, for example, and relays these images to an image analysis device 105 of the higher-level monitoring device, which is included, by way of example, in a control station 5. During this image capturing, one of the spectral filters 121A, 121B, 121C per image is pivoted into the optical beam path of the reflector telescope arrangement 122 in rapid, alternating succession, such that each of the images of the target space captured by the second image sensor 112 is exposed with one of the spectral filters 121A, 121B, 121C. Multiple sequential images therefore produce a near infrared false color image of the target when superimposed with each other, and simultaneously a multispectral analysis of the target space in the near infrared range. This false color image is then relayed to the image analysis device 105 for analysis, such that an automatic multispectral target recognition and target identification is carried out, wherein false targets are recognized as such, and are marked as non-dangerous in the relevant target trajectory file and the relevant target object identification file.

If a target T is detected, for example a missile emitting heat radiation, then the first image sensor 110 is activated. To this end, the deflector mirror 129 is pivoted out of the optical beam path A of the reflector telescope arrangement 122, such that light captured by the reflector telescope arrangement 122 can arrive at the first image sensor 110. At the same time, a target tracking procedure is activated in the higher-level control computer, which functions so that the deflector mirror 1242, which acts as the target tracking mirror, is controlled in such a manner that it tracks the moving target T in such a manner that the target T is constantly imaged on the first image sensor 110. In addition, the image sensor 110 records the target T with a rapid sequence of images, for example at 100 Hz, and relays the obtained image signals to the image analysis device 105. At this point, an object identification of the target T is carried out using the captured image data.

If the target T halts its radiation activity in the wavelength region to which the camera 101 is sensitive, which occurs by way of example upon the completion of combustion of the propulsion system of a launched missile (as target T), then the target illuminating device 104 of the camera system according to the invention, and the mirror arrangement 123, are activated such that the sector aperture wheel rotates. As a result, the high-energy radiation emitted by the beam source 140 of the target illuminating device 104 is deflected to a mirrored sector element of the mirror arrangement 123, and coupled into the optical beam path of the reflector telescope arrangement 122, then directed onto the target T via the target tracking mirror arrangement 124. This high-energy light flash is reflected by the target T and arrives back at the rotating sector aperture 123 via the target tracking mirror arrangement 124 and the reflector telescope arrangement 122, wherein an open sector element of the sector aperture 123 is inserted into the optical beam path at this time point such that the light reflected by the target T can pass through the open sector aperture of the mirror arrangement 123 and arrive at the first image sensor 110. The image sensor 110 can make images of the target T in this manner by means of the radiation emitted by the target illuminating device 104 in a stroboscope-like manner via the rotating sector mirror arrangement 123, even if the target T is no longer emitting its own radiation.

In this manner, this camera system 100 is capable of detecting and identifying a missile with a combusting propulsion system launching from the side of the space being monitored G that is opposite the camera system, at a distance of up to 1200 km. The missile can also continue to be tracked in its flight path even after the completion of combustion of the propulsion system, by means of the on-demand target illuminating device 104. The trajectory tracking of a discovered missile after the completion of combustion is carried out by the camera system positioned the closest in every case, which need only cover a maximum distance of 500 km with the target illuminating device in the geometry shown in FIG. 1.

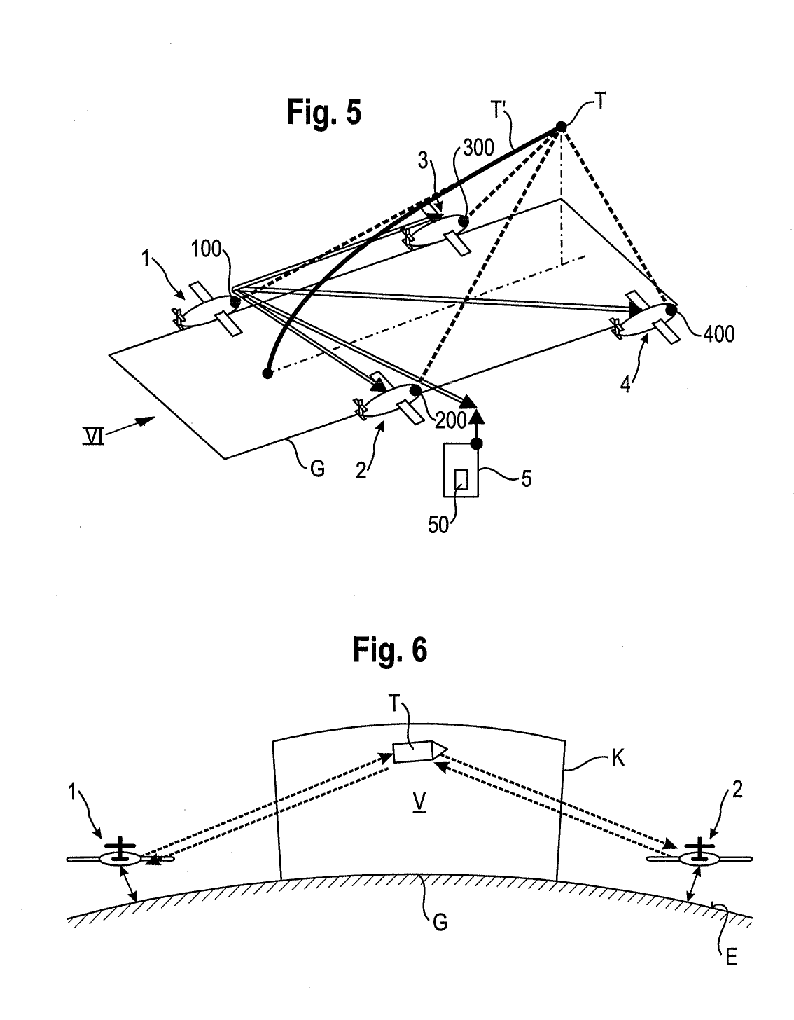

FIG. 5 schematically portrays how the cooperative search method functions by means of multiple airborne monitoring platforms 1, 2, 3, 4.

The individual monitoring platforms 1, 2, 3, 4 have a two-way communication connection to each other and to the control station 5, the same being positioned in the air or on the ground, as is illustrated by the double arrow proceeding from the monitoring platform 1 in FIG. 5, based on the example of the first monitoring platform 1.

In the example shown, every two monitoring platforms 1, 2 and 3, 4 form a monitoring platform pair. The monitoring platforms 1, 2, 3, 4 of each pair are arranged in such a manner that the space being monitored G and/or the monitored part of this space lies between them (FIG. 6). The volume spanning the space G and the corridor K, which defines the airspace V, in this way forms a search volume which is covered by the camera systems of the monitoring platforms 1, 2, 3, 4 with no gaps.

This search volume is initially scanned line-by-line by the camera systems 100, 200, 300, 400 in monitoring mode, by the recording of individual, sequentially strung-together images at close time intervals, for example at a frequency of 100 Hz. The monitoring intervals in this case are selected in such a manner that a launched missile is detected at least three times along the path through the search volume. As soon as a launched missile is detected by the search scan of a first camera system (for example the camera system 100), the camera system 200 of the opposite second monitoring platform 2 is notified. The camera system 200 of this second monitoring platform 2 then directs its search region to the launch space of the missile observed by the first monitoring platform, and/or to the part of the monitored airspace volume V in which the first camera system 100 detected the missile T. Next, a cross-bearing is taken of the detected missile T by means of both camera systems 100, 200 of the pair of monitoring platforms 1, 2, with synchronous clocking, as is illustrated in FIG. 6. In this manner, the current position of the missile T is determined. This cooperative positioning of the missile T is carried out at least three times one after the other, such that the flight trajectory T′ of the missile is determined from the at least three position values so obtained. However, preferably more than three of these cooperative position determinations are carried out, thereby making the measurement of the flight trajectory of the missile more precise. In the process, a further flight trajectory projection is calculated by means of a flight trajectory Kalman filter from the older position determination data of the missile position, in a control computer 50 of the control station 5. Next, the long-focal-distance target tracking procedure is activated in at least one of the camera systems 100, 200, 300, 400, and the camera systems in which this target tracking procedure has been activated are clocked synchronously and directed at the predetermined future missile position. At this position, high-resolution images of the missile, the same still having an exhaust trail, are made.

It is then possible to calculate the precise position of the missile in space, as well as its velocity vector, from the bearings associated with these images. As has already been described above, images of the missile T are made sequentially in three or more different infrared wavelength regions, by means of the filter arrangement 121, and are merged by superimposition to create a multi-color false color image of the missile. These images are then processed with a multispectral analysis program, and a classification and identification of the located missile are carried out. The composite multispectral images have a much better signal to noise ratio than the raw images, given a sufficient number of individual added images, as a result of the averaging of the numerous individual images, thereby achieving an improved recognition rate by means of these composite multispectral images. This multispectral imaging and analysis technique makes it possible to differentiate real missiles from decoys and anomalous bodies.

If the exhaust trail of the missile T, the same having been detected, is extinguished, then the target illuminating device 104 of the respective camera system 100, 200, 300, 400 switches on, as described above, and it is thereby possible to continue the position determination of the missile even after the completion of combustion of the propulsion system in the chronologically successive manner described above. As such, even after the completion of combustion of the propulsion system of the detected missile T, it is possible to determine additional flight trajectory data for the missile, such that the trajectory determination is made more precise.

The range of the target illuminating device need only be at most 500 km in the case of the most efficient distribution of the camera systems, as can be seen in the geometry shown in FIG. 5. In this case, the intensity of the illumination pulse is sufficient to generate an echo pulse which can be easily detected. The missile T must be in range of at least three active camera systems, and suitable lines of sight must exist for a triangulation of the missile position, with sufficiently large angles of view between the respective camera system and the missile. If this is the case, the target illuminating devices 104 of at least three camera systems are activated for the target detection. The camera systems then attempt to home on the target position on the extrapolated target trajectory as synchronously as possible, such that the illumination pulses of all three camera systems arrive at the target at the same time. If a first location attempt fails, the immediate surroundings of the extrapolated target position are synchronously scanned until the missile T has been acquired once more. By means of the synchronous illumination of the target by multiple target illuminating devices, the effective illumination of the missile T is multiplied by the number of the activated target illuminating devices, if these target illuminating devices are oriented at the same side of the missile T. In this case, it is advantageous if the entire effective spectral region is detected in monochrome images, in order to achieve the highest sensitivity.

Once the missile has been detected, a search is made in the surroundings of the missile for further parts thereof, by means of a camera scan, and a flight trajectory tracking is carried out for all detected objects. The flight trajectories of various objects, determined in this manner, are sent to the control computer 50 and saved by the same as different flight trajectory paths in one target tracking file, wherein the same is continuously updated. In this manner, it is possible to determine whether a missile sets off multiple secondary missiles, by way of example, which are intended to attack different targets. If the flight trajectories of all detected objects have been measured stably, further measurements are carried out using the on-demand spectral filters 121A, 121B, 121C. This plurality of spectral images of each detected object is then merged to create composite multispectral images, in order to then enable an identification of the detected objects by means of a multispectral image recognition process. In this manner, it is possible to differentiate between single and multiple warheads, burned-out missile stages and decoys, and to differentiate harmless parts of missiles from dangerous parts.

For the purpose of the position determination and location determination of each monitoring platform 1, 2, 3, 4, not only satellite navigation data (GPS satellite signals) and inertial navigation data are used. Rather, a pivot bearing determination is carried out by star observation, by means of a stellar attitude reference system, wherein each camera of the camera system of the monitoring platform is directed at one or more stars. By comparison with the data of a star chart carried in a database, the three orientation angles in space are determined. Because of the use of the same telescope camera system for both the orientation angle determination of the monitoring platform and the line of sight angle determination of the homed-on target, the adjustment errors of the camera lens and angle sensors of the camera system are largely cancelled out, thereby improving the residual precision of the position data for the homed-on targets. Calculations have shown that it is possible to determine the trajectory data of a detected missile at fifty times greater precision by means of adding a stellar navigation to the conventional satellite navigation, in this manner, compared to using only satellite navigation. In addition, the airspace region in which the target can be found during later measurements is much smaller as a result of this improved measurement precision, such that a target detection using extrapolated trajectory data can take place much more quickly.

By means of the combined image recognition, the observation of activities of the detected missile, and the analysis of the flight trajectory as described above, it is possible to detect the target of the attacking missile, and/or of the multiple warheads released by the same, early, such that the time for the preparation of the missile defense is longer compared to conventional methods, and the attacking missile and/or the attacking multiple warheads can be intercepted far from their targets.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

Reference numbers in the claims, in the description, and in the drawings only serve to facilitate understanding of the invention, and should not restrict the scope of protection.

### LIST OF REFERENCE NUMBERS

1 monitoring platform
2 monitoring platform
3 monitoring platform
4 monitoring platform
10 line of sight
12 upper edge rays
14 upper edge rays
20 line of sight
22 upper edge rays
24 upper edge rays
30 line of sight
40 line of sight
100 camera system
101 camera
102 camera lens
103 camera platform
130 position stabilizer device
110 first image sensor
111 high-speed shutter
112 second image sensor
113 high-speed shutter
114 high-frequency line of sight stabilizer and image rotator device
115 high-frequency line of sight stabilizer and image rotator device
120 device
   121 filter arrangement
   121A spectral filter
   121B spectral filter
   121C spectral filter
   122 reflector telescope arrangement
   123 reflector arrangement
   123′ dashed line
   124 target tracking mirror arrangement
   126 first sub-unit
   127 fluorite flatfield corrector
   128 second sub-unit
   129 deflector mirror
   130 position stabilizer device
   140 first beam surface
   141 arc lamp
   142 reflector
   143 condenser lens
   144 sapphire glass
   145 aperture block
   145′ light transmission opening
   145″ emission aperture
   146 illumination condenser
   200 camera system
   300 camera system
   400 camera system
   1220 mirror
   1220′ aperture
   1222 mirror
   1240 further deflector mirror
   1242 second deflector mirror
   1242′ holder for deflector mirror 1242
   1242″ holder for deflector mirror 1242
   1244 drive device
   1244′ moving element of the drive device 1244
   1246 control device
   A optical axis
   A′ optical axis
   A″ optical axis
   A′″ optical axis
   B boundary of the territory
   E surface of the earth
   G space being monitored
   K monitoring corridor
   S territory
   T target
   T′ flight path
   V airspace region
   f1 first focal distance
   f2 second focal distance
   x first axis
   y second axis

1-19. (canceled)

20. An airspace surveillance system for the detection of missiles launched within a space being monitored, the system comprising:
at least two monitoring platforms positioned outside or on an edge of the space being monitored, in such a manner that the space being monitored or a part of the space being monitored is situated between the monitoring platforms,
wherein each of the monitoring platforms includes at least one camera system configured in such a manner that lines of sight of the camera systems of two monitoring platforms are positioned opposite each other and face each other.

21. The airspace surveillance system according to claim 20, wherein the at least two monitoring platforms include three or more monitoring platforms configured at positions spaced apart from each other, outside or on the edge of the space being monitored.

22. The airspace surveillance system according to claim 21, wherein the at least two monitoring platforms include at least two pairs of the monitoring platforms, wherein the space being monitored or a part of the space being monitored is situated between two monitoring platforms of each pair.

23. The airspace surveillance system according to claim 20, wherein each of the camera systems is configured to detect and track a trajectory of moving objects located at a great distance, and each of the camera systems comprises
a camera configured with a camera lens; and
a position stabilizer device configured to stabilize the camera and the camera lens,
wherein the camera of each camera system comprises
a first image sensor with a first high-speed shutter functionally assigned to the first image sensor;
a second image sensor with a second high-speed shutter functionally assigned to the second image sensor;
wherein the camera lens has a device consisting of optical elements configured to focus incident radiation onto a radiation-sensitive surface of the first image sensor or of the second image sensor, by way of at least one reflector telescope arrangement and at least one target tracking mirror arrangement,
wherein the at least one target tracking minor arrangement comprises
a drive device for at least one moving element of the target tracking mirror arrangement and
a control device for the drive device, and
wherein the device consisting of optical elements comprises
a first sub-unit of optical elements functionally assigned to the first image sensor and having a first focal distance, and
a second sub-unit of optical elements functionally assigned to the second image sensor and having a second focal distance that is shorter than the first focal distance.

24. The airspace surveillance system according to claim 23, wherein an optical beam path of each of the camera systems is switchable can be switched between the first sub-unit and the second sub-unit, wherein a moving and pivotable minor is configured to affect the switching.

25. The airspace surveillance system according to claim 23, wherein each image sensor of the camera system has a sensitivity maximum in a spectral wavelength range from 0.7 μm to 1.7 μm.

26. The airspace surveillance system according to claim 23, wherein the camera of the camera system has a filter arrangement consisting of multiple spectral filters that are insertable into the optical beam path as required, the filter arrangement is a filter wheel.

27. The airspace surveillance system according to claim 23, wherein in the camera system includes:
a target illuminating device having a beam source that is one of a laser beam source configured as a laser array or as a xenon short-arc lamp with an aspherical collimator lens and pinhole collimator,
wherein the target illuminating device is coupled to the camera lens in such a manner that a target illuminating beam emitted by the target illuminating device is coupleable into the optical beam path of the camera lens to focus the emitted radiation, and
wherein the camera lens has a reflector arrangement configured to couple the target illuminating beam into the optical beam path of the camera lens, the reflector arrangement is configured in such a manner that the beam path of the camera lens is switchable between the first image sensor and the target illuminating device.

28. The airspace surveillance system according to claim 23, wherein the camera system is configured with or connected to an automatic image analysis device, wherein image data of images recorded by the camera is transmitted to the image analysis device.

29. The airspace surveillance system according to claim 20, wherein the monitoring platforms are airborne, and are each composed of an airplane or are on board an airplane.

30. The airspace surveillance system according to claim 29, wherein each airplane is a high-altitude airplane, and is positioned at an elevation of the stratosphere at an altitude of approximately 38 km.

31. The airspace surveillance system according to claim 20, further comprising:
a pivot device configured to pivot the camera system between a monitoring position, a navigation position, and a communication position.

32. The airspace surveillance system according to claim 27, wherein the beam source of the target illuminating device is configured for modulation by means of a data coupling device in order to transmit data using a modulated radiation signal output when in a communication position.

33. A method for airspace surveillance using an airspace surveillance system, the method comprising:
systematically searching the airspace or a region of the airspace over a space being monitored using at least one camera system of each of a plurality of monitoring platforms, in a scanning procedure, wherein the camera system works in a scanning mode for objects that give off a significantly higher heat radiation in proportion to their surroundings;
switching over the at least one camera system over from the scanning mode to a target tracking mode of a tracking procedure when an object giving off a large amount of heat radiation has been detected;
recording, by the at least one camera system, a smaller image segment containing the detected object by means of a greater focal distance; and
tracking, by the at least one camera system, the detected moving object.

34. The method for airspace surveillance according to claim 33, wherein an object recognition procedure for the detected object is performed by means of an image analysis process once the camera system has been switched over to the target tracking mode to identify the object using image data saved in a database.

35. The method for airspace surveillance according to claim 33, wherein the target tracking mode of the camera system, involves activating a target illuminating device that illuminates the object when heat radiation signal emitted by the detected object disappears or drops below a prespecified threshold.

36. The method for airspace surveillance according to claim 33, wherein the camera system of each monitoring platform is oriented from a location of the associated monitoring platform, through the monitored area of the airspace of the space being monitored, and toward outer space.

37. The method for airspace surveillance according to claim 33, wherein following the detection of an object by one camera system of a monitoring platform, transmitting information on a line of sight and therefore on a sector of the monitored airspace in which the object was detected from the detecting camera system to at least two camera systems, of at least two other monitoring platforms such that the at least two other monitoring platforms direct their scanning activity to the sector of the monitored airspace, and then, once at least one of the at least two camera systems has detected the object, the camera systems that have detected the object then synchronously home on the object in order to determine a current position and a trajectory of the detected object.

38. The method for airspace surveillance according to claim 33, wherein each monitoring platform takes it own bearings from stars, using the camera of its camera system, to determine its position.
